(19) United States
(12) Patent Application Publication
(10) Pub. No.: US 2026/0118660 A1
(43) Pub. Date: Apr. 30, 2026

(54) SCANNING OPTICAL DEVICE

(71) Applicant: BROTHER KOGYO KABUSHIKI KAISHA, Nagoya (JP)

(72) Inventor: Junichi HIRAOKA, Nagoya (JP)

(21) Appl. No.: 19/371,346

(22) Filed: Oct. 28, 2025

(30) Foreign Application Priority Data
Oct. 30, 2024 (JP) 2024-190342

(51) Int. Cl. G02B 26/12; B41J 2/44; B41J 2/47; G03G 15/04; G03G 15/043

(52) U.S. Cl. CPC G02B 26/125; B41J 2/44; B41J 2/471; G03G 15/04036; G03G 15/0435

(57) ABSTRACT

A scanning optical device includes a light source, an optical deflector, a scanning optical system, a frame, and a leaf spring. The optical deflector includes a polygon mirror rotatable about a rotation axis extending in a first direction perpendicular to a main scanning direction. The scanning optical system includes a scan lens. The scan lens includes a lens portion and a flange extending in the main scanning direction from an end of the lens portion in the main scanning direction. The frame includes a contact wall positioned further away, than the flange, from the rotation axis in a second direction perpendicular to the main scanning direction and the first direction. The leaf spring includes a base and a first arm configured to hold the contact wall and the flange in combination with the base and bias the flange toward the contact wall.

### REFERENCE TO RELATED APPLICATIONS

This application claims priority from Japanese Patent Application No. 2024-190342 filed on Oct. 30, 2024. The entire contents of the priority application are incorporated herein by reference.

### BACKGROUND ART

A scanning optical device known in the art includes a polygon mirror, a scan lens through which light beams deflected by the polygon mirror pass, a frame which supports the scan lens, and a leaf spring which fixes the scan lens to the frame. In such a scanning optical device, the frame has a contact wall on a side of the scan lens on which the polygon mirror is located. The leaf spring is attached to the frame such that the leaf spring holds the contact wall and a longitudinal end portion of the scan lens.

### SUMMARY

When such scanning optical device is downsized, the distance between the polygon mirror and the scan lens becomes smaller, and in turn the distance between the polygon mirror and the contact wall becomes smaller. In such scanning device, since the contact wall is located on the side of the scan lens on which the polygon mirror is located, the leaf spring may interfere with the polygon mirror, for example, when the leaf spring is attached to the frame.

It would be desirable to provide a scanning optical device in which the distance between a polygon mirror and a contact wall can be secured even when the distance between the polygon mirror and a scan lens becomes smaller.

In one aspect, a scanning optical device disclosed herein includes a light source, an optical deflector, a scanning optical system, a frame, and a leaf spring.

The light source emits a light beam.

The optical deflector deflects the light beam in a main scanning direction. The optical deflector includes a polygon mirror rotatable about a rotation axis extending in a first direction perpendicular to the main scanning direction.

The scanning optical system causes the light beam deflected by the optical deflector to be focused on a scanning surface to form an image thereon. The scanning optical system includes a scan lens through which the light beam deflected by the optical deflector passes.

The frame supports the optical deflector and the scan lens.

The leaf spring fixes the scan lens to the frame.

The scan lens includes a lens portion and a flange.

The flange extends from an end of the lens portion in the main scanning direction.

The frame includes a contact wall in contact with the flange in a second direction perpendicular to the main scanning direction and to the first direction. The contact wall is positioned further away, than the flange, from the rotation axis in the second direction.

The leaf spring includes a base and a first arm.

The base is in contact with a side of the contact wall opposite to the flange in the second direction.

The first arm extends from an end of the base on one side in the first direction. The first arm holds the contact wall and the flange in combination with the base.

Since the contact wall is farther, than the flange, from the rotation axis of the polygon mirror in the second direction, clearance between the polygon mirror and the contact wall can be secured even if the distance between the polygon mirror and the scan lens becomes smaller.

The first arm may include two arm portions. The two arm portions extend from the end of the base on the one side in the first direction and hold the contact wall and the flange in combination with the base. The two arm portions are spaced apart from each other in the main scanning direction.

Since the first arm includes the two arm portions, the load for biasing the flange toward the contact wall can be obtained.

The first arm may include a connecting portion.

The connecting portion may extend in the main scanning direction. The connecting portion connects an end portion of one of the arm portions opposite to the base with an end portion of the other of the arm portions opposite to the base.

Since the first arm includes the connecting portion connecting the two arm portions, the first arm including the two arm portions can be moved as one when the leaf spring is attached to the frame. As a result, the leaf spring can be attached to the frame easily.

The leaf spring may include a second arm. The second arm extends from the end of the base on the one side in the first direction. The second arm is positioned between the two arm portions in the main scanning direction. The second arm contacts an end of the flange on the one side in the first direction.

Since the leaf spring includes the first arm and the second arm, the flange can be biased in the second direction toward the contact wall and biased in the first direction by a single leaf spring.

The optical deflector may include a support plate that supports the polygon mirror. The leaf spring may not overlap the support plate as viewed in the first direction.

Since the leaf plate does not overlap the support plate of the optical deflector as viewed in the first direction, the leaf spring and the optical deflector can be restrained from interfering with each other when the leaf spring or the optical deflector is attached to the frame along the first direction.

The flange may may be a first flange, the contact wall may be a first contact wall, and the leaf spring may be a first leaf spring. The scanning optical sensor may further include a second flange, a second contact wall, and a second leaf spring.

The first flange extends from one end of the lens portion on one side in the main scanning direction.

The second flange extends from the other end of the lens portion on the other side in the main scanning direction.

The first contact wall contacts the first flange.

The second contact wall contacts the second flange.

The first leaf spring holds the first contact wall and the first flange.

The second leaf spring holds the second contact wall and the second flange.

At least one of the first leaf spring or the second leaf spring may be positioned between one end of the support plate on the one side in the main scanning direction and the other end of the support plate on the other side in the main scanning direction.

Since the at least one of the first leaf spring or the second leaf spring is positioned between the one end of the support plate on the one side in the main scanning direction and the other end of the support plate on the other side in the main scanning direction, the scan lens, the first leaf spring, the second leaf spring, and the optical deflector can be disposed in a compact manner in the main scanning direction.

Both the first leaf spring and the second leaf spring may be positioned between the one end of the support plate on the one side in the main scanning direction and the other end of the support plate on the other side in the main scanning direction.

The frame may include a wall and a plurality of ribs. The wall extends in the main scanning direction and the first direction. The plurality of ribs protrudes from the wall toward the rotation axis in the second direction. The plurality of ribs extends in the first direction and are arranged in the main scanning direction.

Since the frame includes the plurality of ribs, the support plate can be guided by the plurality of ribs when the optical deflector is attached to the frame. As a result, the optical deflector can be restrained from interfering with the leaf spring when the optical deflector is attached to the frame.

The plurality of ribs may be disposed on each side of the support plate in the second direction.

Since the frame includes the plurality of ribs on each side of the support plate in the second direction, the optical deflector can be restrained from interfering with the leaf spring when the optical deflector is attached to the frame.

The scan lens may include an incident-side surface through which the light beam deflected by the optical deflector enters the scan lens, and the incident-side surface may be a concave surface.

Since the incident-side surface is a concave surface, clearance between the polygon mirror and the contact wall can be secured even when the distance between the polygon mirror and the scan lens becomes smaller.

In another aspect, an image forming apparatus disclosed herein includes a photosensitive drum and a scanning optical device.

The scanning optical device includes a light source, an optical deflector, a scanning optical system, a frame, and a leaf spring.

The light source emits a light beam.

The optical deflector deflects the light beam in a main scanning direction. The optical deflector includes a polygon mirror rotatable about a rotation axis extending in a first direction perpendicular to the main scanning direction.

The scanning optical system causes the light beam deflected by the optical deflector to be focused on a surface of the photosensitive drum to form an image thereon. The scanning optical system includes a scan lens through which the light beam deflected by the optical deflector passes.

The frame supports the optical deflector and the scan lens.

The leaf spring fixes the scan lens to the frame.

The scan lens includes a lens portion and a flange.

The flange extends from an end of the lens portion in the main scanning direction.

The frame includes a contact wall in contact with the flange in a second direction perpendicular to the main scanning direction and to the first direction. The contact wall is positioned further away, than the flange, from the rotation axis in the second direction.

The leaf spring includes a base and a first arm.

The base is in contact with a side of the contact wall opposite to the flange in the second direction.

The first arm extends from an end of the base on one side in the first direction. The first arm holds the contact wall and the flange in combination with the base.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is a cross-sectional view of an image forming apparatus comprising a scanning optical device.

FIG. 2 is a perspective view of the scanning optical device.

FIG. 3 is a cross-sectional view taken along line X-X of FIG. 2.

FIG. 4 is a cross-sectional view taken along line Y-Y of FIG. 2

FIG. 5 is an illustration showing the scanning optical device with the cover taken off, as viewed from one side in a first direction.

FIG. 6 is a perspective view of the vicinity of an optical deflector of the scanning optical device.

FIG. 7 is a perspective view of the vicinity of a contact wall, the optical deflector, a scan lens, and a leaf spring.

FIG. 8 is an illustration showing the vicinity of the scan lens of the scanning optical device as viewed from one side in a main scanning direction.

FIG. 9A is a perspective view of the leaf spring.

FIG. 9B is a perspective view of the leaf spring as viewed from a direction different from FIG. 9A.

FIG. 10 is an illustration of the vicinity of the optical deflector of the scanning optical device as viewed from one side in the first direction.

FIG. 11 is a perspective view showing plate guide rib of the frame.

### DESCRIPTION

An embodiment of the present disclosure will be described in detail referring to the drawings where appropriate.

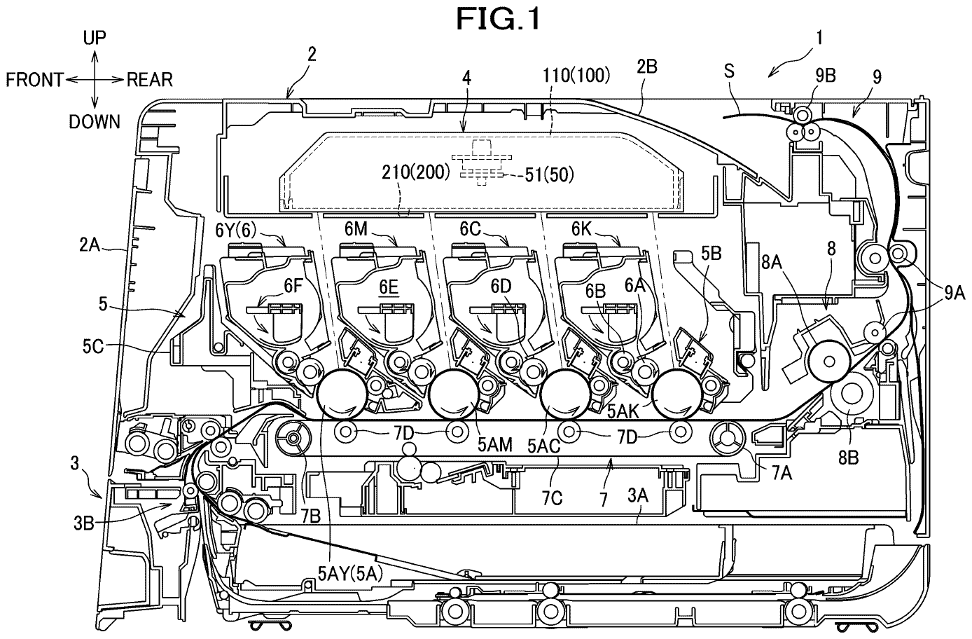

An example of an image forming apparatus 1 is shown in FIG. 1, which is an electrophotographic image forming apparatus. In the present embodiment, the image forming apparatus 1 is a multi-color laser printer. The image forming apparatus 1 comprises a main housing 2, a sheet feeder unit 3, a scanning optical device 4, a drum unit 5, four development cartridges 6, a transfer unit 7, a fixing unit 8, and a sheet ejection unit 9.

The main housing 2 comprises a front cover 2A and an output tray 2B. The front cover 2A covers and uncovers an opening formed on the front side of the main housing 2.

The sheet feeder unit 3 is located in a lower portion of the main housing 2. The sheet feeder unit 3 comprises a sheet tray 3A and a sheet feeding mechanism 3B. The sheet tray 3A contains sheets S of paper or the like. The sheet feeding mechanism 3B feeds the sheets S in the sheet tray 3A to a position between a photosensitive drum 5A and a transfer belt 7C.

The scanning optical device 4 is located in an upper portion of the main housing 2. The scanning optical device 4 emits light beams, shown by dashed-double dotted lines, to expose surfaces of the photosensitive drums 5A.

The drum unit 5 is located between the sheet tray 3A and the scanning optical device 4 in the main housing 2. The drum unit 5 is installable into and removable from the main housing 2 through the opening of the main housing 2 which is uncovered by opening the front cover 2A. The drum unit 5 comprises four photosensitive drums 5A, four chargers 5B, and a drum frame 5C. The drum frame supports the photosensitive drums 5A and the chargers 5B.

In the present embodiment, the photosensitive drums 5A include a photosensitive drum 5AY on which a toner image of yellow is formed, a photosensitive drum 5AM on which a toner image of magenta is formed, a photosensitive drum 5AC on which a toner image of cyan is formed, and a photosensitive drum 5AK on which a toner image of black is formed. The four photosensitive drums 5A, i.e., the photosensitive drum 5AY, the photosensitive drum 5AM, the photosensitive drum 5AC, and the photosensitive drum 5AK, are arranged in this order from the front to the rear, i.e., from upstream to downstream in the direction of conveyance of each sheet S.

The development cartridges 6 are installable into and removable from the drum frame 5C of the drum unit 5. Each development cartridge 6 comprises a development roller 6A, a supply roller 6B, a doctor blade 6D, a toner containing unit 6E, and an agitator 6F.

The agitator 6F agitates toner in the toner containing unit 6E. The agitator 6F supplies toner in the toner containing unit 6E to the supply roller 6B. The supply roller 6B supplies toner to the development roller 6A. The doctor blade 6D adjust the thickness of toner on the development roller 6A to a uniform thickness.

The development cartridges 6 each contains toner of a different color. In the present embodiment, the development cartridges 6 include a development cartridge 6Y containing yellow toner, a development cartridge 6M containing magenta toner, a development cartridge 6C containing cyan toner, and a development cartridge 6K containing black toner.

The transfer unit 7 is located between the sheet tray 3A and the drum unit 5. The transfer unit 7 comprises a drive roller 7A, a follower roller 7B, a transfer belt 7C, and four transfer rollers 7D. The transfer belt 7C is an endless belt. The drive roller 7A and the follower roller 7B cause the transfer belt 7C to rotate. The transfer rollers 7D face an inner surface of the transfer belt 7C. The transfer rollers 7D nip the transfer belt 7C in combination with the photosensitive drums 5A.

The fixing device 8 is disposed rearward of the drum unit 5. The fixing device 8 comprises a heating roller 8A and a pressure roller 8B. The heating roller 8A heats the sheet S. The pressure roller 8B nips the sheet S in combination with the heating roller 8A.

Each of the chargers 5B charge the surface of the corresponding photosensitive drums 5A. The optical scanning device 4 emits light beams to expose the surfaces of photosensitive drums 5A. Electrostatic latent images are thereby formed on the photosensitive drums 5A. The development rollers 6A supply toner to the corresponding photosensitive drums 5A. Toner images are thereby formed on the photosensitive drums 5A.

The photosensitive drums 5A on which the toner images are formed convey the sheet S in combination with the transfer rollers 7D. The toner images on the photosensitive drums 5A are thereby transferred onto the sheet S. The sheet S on which the toner images are transferred is conveyed by the heating roller 8A and the pressure roller 8B. The toner images on the sheet S are thereby fixed on the sheet S.

The sheet ejection unit 9 comprises conveyor rollers 9A and an ejection roller 9B. The conveyor rollers 9A convey the sheet S on which the toner images are fixed to the ejection roller 9B. The ejection roller 9B ejects the sheet S onto the output tray 2B.

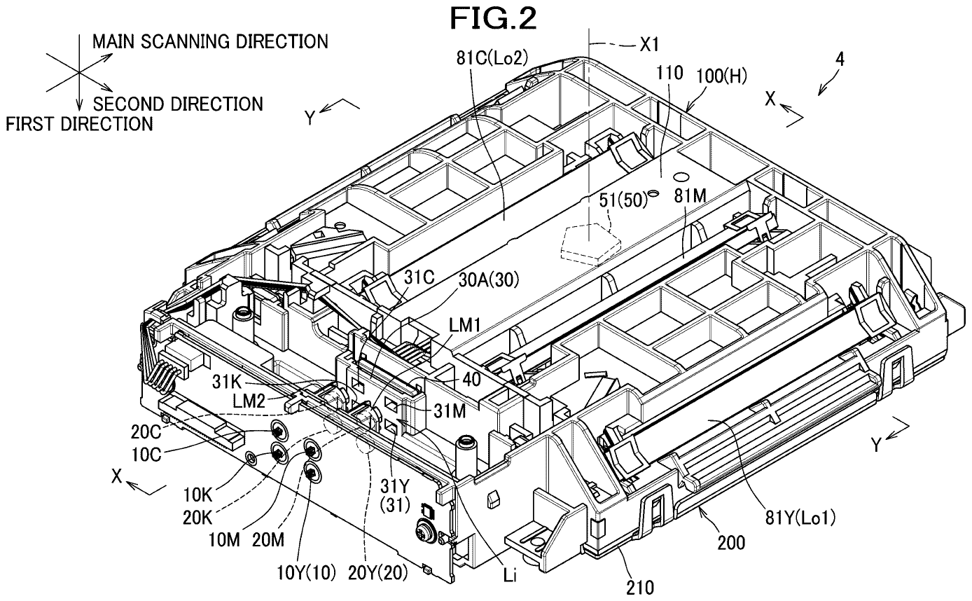

As shown in FIG. 2, the scanning optical device 4 comprises a housing H, an illumination optical system Li, an optical deflector 50, and scanning optical systems Lo1 and Lo2. In the drawings referred to in the specification, the arrows showing the main scanning direction, the first direction, and the second direction point to one side in each of the directions. The side opposite to the one side is the other side in each of the directions.

The first direction is a direction perpendicular to the main scanning direction. In the present embodiment, the first direction is a direction in which a rotation axis X1 of a polygon mirror 51 of the optical deflector 50 extends. The second direction is a direction perpendicular to the main scanning direction and the first direction.

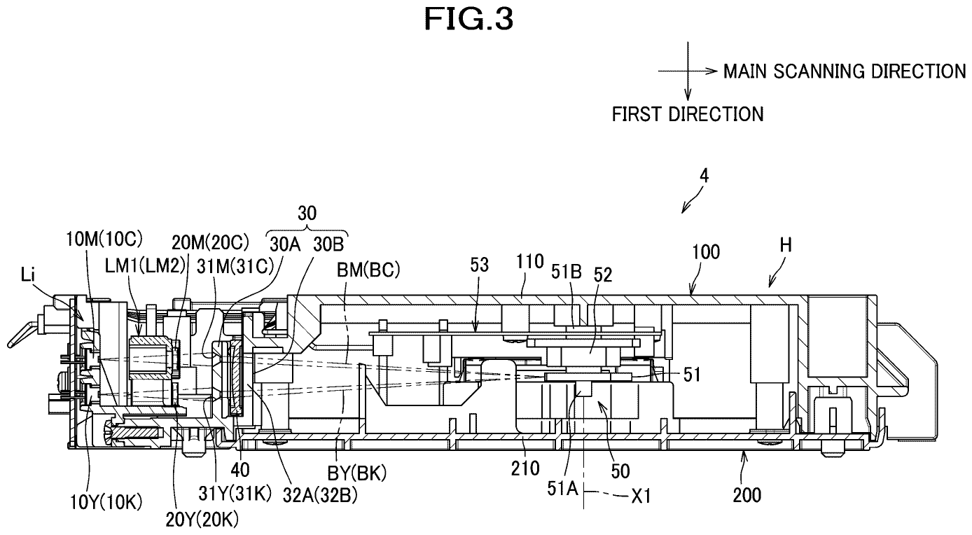

As shown in FIG. 3, the housing H comprises a frame 100 and a cover 200.

The frame 100 comprises a frame base wall 110 on the other side in the first direction. The frame base wall 110 is a wall on which the deflector 50 is mounted.

The cover 200 comprises a cover base wall 210 on one side in the first direction. The cover base wall 210 is a wall covering the optical deflector 50 from a side opposite to a side on which the frame base wall 110 is located in the first direction. In other words, the cover base wall 210 covers the optical deflector 50 from the one side in the first direction.

In the present embodiment, the scanning optical device 4 is disposed in the main housing 2 of the image forming apparatus 1 such that the frame base wall 110 is located above the optical deflector 50 and the cover base wall 210 is located below the optical deflector 50 (see FIG. 1). In other words, in the present embodiment, the first direction corresponds to the up-down direction of the image forming apparatus 1. Furthermore, the one side in the first direction corresponds to the side below the image forming apparatus 1, and the other side in the first direction corresponds to the side above the image forming apparatus 1.

The illumination optical system Li comprises light source units LM1 and LM2, diaphragm walls 30, and a condenser lens 40.

The light source units LM1 and LM2 are units which emit light beams BY, BM, BC, and BK. More specifically, the light source unit LM1 emits light beams BY and BM. The light source unit LM2 emits light beams BC and BK.

As shown in FIG. 2, each of the light source units LM1 and LM2 comprises two semiconductor lasers 10 and two coupling lenses 20. More specifically, the light source unit LM1 comprises a semiconductor laser 10Y, a semiconductor laser 10M, a coupling lens 20Y, and a coupling lens 20M. The light source unit LM2 comprises a semiconductor laser 10C, a semiconductor laser 10K, a coupling lens 20C, and a coupling lens 20K.

The semiconductor laser 10Y emits a laser beam that exposes the photosensitive drum 5AY corresponding to yellow. The semiconductor laser 10M emits a laser beam that exposes the photosensitive drum 5AM corresponding to magenta. The semiconductor laser 10C emits a laser beam that exposes the photosensitive drum 5AC corresponding to cyan. The semiconductor laser 10K emits a laser beam that exposes the photosensitive drum 5AK corresponding to black.

The coupling lens 20Y converts the laser beams emitted by the semiconductor laser 10Y into the light beam BY. The coupling lens 20M converts the laser beams emitted by the semiconductor laser 10M into the light beam BM. The coupling lens 20C converts the laser beams emitted by the semiconductor laser 10C into the light beam BC. The coupling lens 20K converts the laser beams emitted by the semiconductor laser 10K into the light beam BK

As shown in FIG. 3, the condenser lens 40 is a lens configured to refract the light beams BY, BM, BC, and BK received from the coupling lenses 20 in the sub-scanning direction. The condenser lens 40 concentrates the light beams BY, BM, BC, and BK on a reflector of the polygon mirror 51. The sub-scanning direction of the illumination optical system Li corresponds to the first direction.

In the present embodiment, the condenser lens 40 is a cylindrical lens in which an incident-side surface is a cylindrical surface and an exit-side surface is a flat surface. The condenser lens 40 refracts the light beams BY and BK in the first direction toward the frame base wall 110 and concentrates the light beams BY and BK on the reflector of the polygon mirror 51. The condenser lens 40 refracts the light beams BM and BC in the first direction toward the cover base wall 210 and concentrates the light beams BM and BC on the reflector of the polygon mirror 51.

The diaphragm walls 30 include a first diaphragm wall 30A and a second diaphragm wall 30B. In the present embodiment, the first diaphragm wall 30A and the second diaphragm wall 30B are formed integrally with the frame 100. In other words, the frame 100 comprises the first diaphragm wall 30A and the second diaphragm wall 30B.

The first diaphragm wall 30A is a wall located between the coupling lenses 20Y, 20M, 20C, and 20K and the condenser lens 40. Openings 31 (see FIG. 2) are formed in the first diaphragm wall 30A. The openings 31 include an opening 31Y through which the light beam BY heading toward the polygon mirror 51 from the coupling lens 20Y passes, an opening 31M through which the light beam BM heading toward the polygon mirror 51 from the coupling lens 20M passes, an opening 31C through which the light beam BC heading toward the polygon mirror 51 from the coupling lens 20C passes, and an opening 31 through which the light beam BK heading toward the polygon mirror 51 from the coupling lens 20K passes.

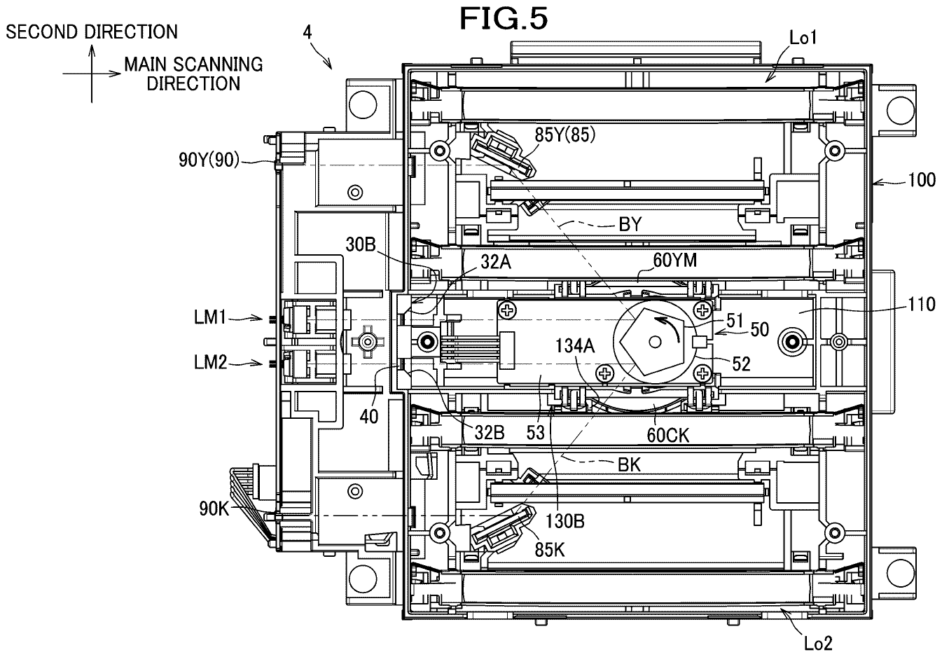

The second diaphragm wall 30B is a wall located between the condenser lens 40 and the optical deflector 50. The condenser lens 40 is located between the first diaphragm wall 30A and the second diaphragm wall 30B. Two openings 32A and 32B are formed in the second diaphragm wall 30B (see also FIG. 5). The opening 32A is an opening through which the light beams BY and BM heading toward the polygon mirror 51 from the coupling lenses 20Y and 20M pass. The opening 32B is an opening through which the light beams BC and BK heading toward the polygon mirror 51 from the coupling lenses 20C and 20K pass.

The optical deflector 50 deflects the light beams BY, BM, BC, and BK in the main scanning direction. The optical deflector 50 comprises a polygon mirror 51, a motor 52, and a support plate 53.

The polygon mirror 51 is rotatable about a rotation axis X1 extending in the first direction. The polygon mirror 51 has five reflectors provided in locations equidistant from the rotation axis X1 (see also FIG. 2). The polygon mirror 51 is configured to deflect the light beams BY, BM, BC, and BK in the main scanning direction by rotating.

The motor 52 is a motor that causes the polygon mirror 51 to rotate. The motor 52 is fixed to the frame 100 via the support plate 53.

The support plate 53 is made of a metal plate and supports the polygon mirror 51 and the motor 52. More specifically, the support plate 53 supports a bearing 51B and the motor 52. The bearing 51B is a bearing that supports a shaft 51A of the polygon mirror 51 in a rotatable manner. Further, the support plate 53 supports a circuit board on which circuits such as a drive circuit of the motor 52 is formed (not shown in the drawings).

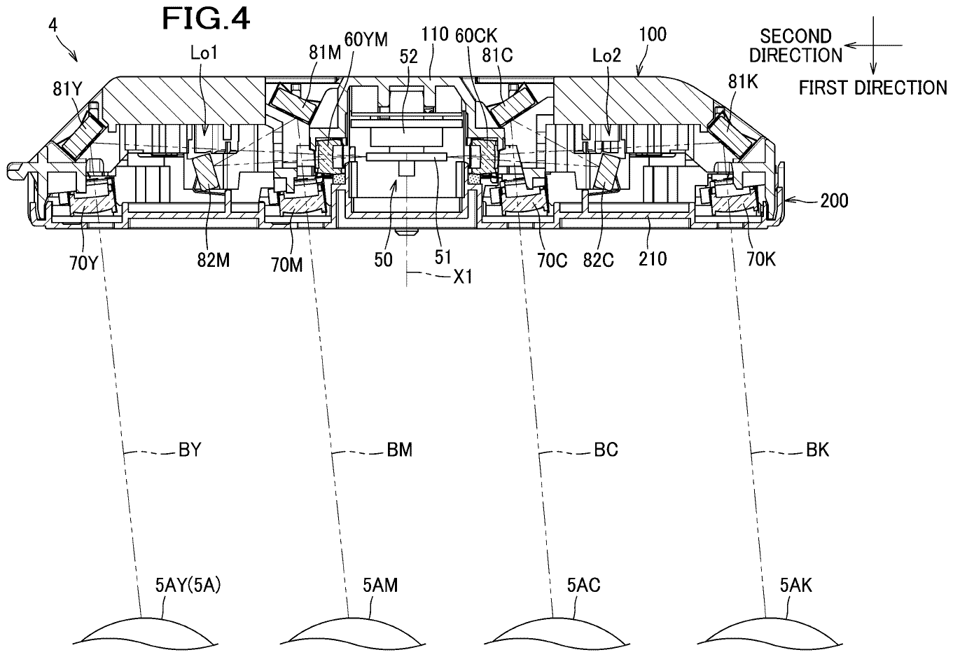

As shown in FIG. 4, the scanning optical systems Lo1 and Lo2 are optical systems configured to cause light beams BY, BM, BC, and BK deflected by the optical deflector 50 to be focused on the surfaces of the photosensitive drums 5A to form images thereon. The surfaces of the photosensitive drums correspond to the “scanning surface” in the present embodiment.

The scanning optical system Lo1 causes the light beam BY deflected by the optical deflector 50 to be focused on the surface of the photosensitive drum 5AY to form an image thereon, and causes the light beam BM deflected by the optical deflector 50 to be focused on the surface of the photosensitive drum 5AM to form an image thereon. The scanning optical system Lo2 causes the light beam BC deflected by the optical deflector 50 to be focused on the surface of the photosensitive drum 5AC to form an image thereon, and causes the light beam BK deflected by the optical deflector 50 to be focused on the surface of the photosensitive drum 5AK to form an image thereon. The polygon mirror 51 is located between the scanning optical system Lo1 and the scanning optical system Lo2 in the second direction.

The scanning optical system Lo1 comprises scan lenses 60YM, 70Y, and 70M, and mirrors 81Y, 81M, and 82M. The scanning optical system Lo2 comprises scan lenses 60CK, 70C, and 70K, and mirrors 81C, 81K, and 82C. Each of the components of the scanning optical systems Lo1 and Lo2 are fixed to the frame 100.

The scan lens 60YM is a lens that receives the light beams BY and BM deflected by the optical deflector 50. The scan lens 60CK is a lens that receives the light beams BC and BK deflected by the optical deflector 50.

The scan lenses 60YM and 60CK cause the light beams BY, BM, BC, and BK deflected by the optical deflector 50 to be refracted in the main scanning direction, so that each of the light beams BY, BM, BC and BK is focused on the surface of the corresponding photosensitive drum 5A to form an image thereon. Furthermore, the scan lenses 60YM and 60CK have an fθ characteristic such that each of the light beams BY, BM, BC, and BK deflected by the optical deflector 50 in a constant angular velocity scan the surface of the corresponding photosensitive drum 5A at a constant linear velocity.

The scan lens 60YM and the scan lens 60CK are arranged symmetrically with respect to a plane perpendicular to the second direction which passes through the rotation axis X1 of the polygon mirror 51. The polygon mirror 51 is located between the scan lens 60YM and the scan lens 60CK in the second direction.

The mirror 81Y is a mirror configured to reflect the light beam BY that has passed through the scan lens 60YM toward the surface of the photosensitive drum 5AY.

The scan lens 70Y is a lens configured to cause the light beam BY reflected off the mirror 81Y to be focused on the surface of the photosensitive drum 5AY to form an image thereon. Each of the scan lenses 70Y, 70M. 70C, and 70K cause the corresponding light beams BY, BM, BC, and BK to be refracted in the sub-scanning direction, so that each of the light beams BY, BM, BC, and BK is focused on the surface of the corresponding photosensitive drum 5A to form images thereon. In the scanning optical systems Lo1 and Lo2, the sub-scanning direction corresponds to a direction perpendicular to the main scanning direction and the direction in which the light beams BY, BM, BC, and BK travel.

The mirror 82M is a mirror configured to reflect the light beam BM that has passed through the scan lens 60YM toward the mirror 81M. The mirror 81M is a mirror configured to reflect the light beam BM toward the surface of the photosensitive drum 5AM.

The scan lens 70M is a lens configured to cause the light beam BM reflected off the mirror 81M to be focused on the surface of the photosensitive drum 5AM to form an image thereon.

The mirror 82C is a mirror configured to reflect the light beam BC that has passed through the scan lens 60CK toward the mirror 81C. The mirror 81C is a mirror configured to reflect the light beam BC toward the surface of the photosensitive drum 5AC.

The scan lens 70C is a lens configured to cause the light beam BC reflected off the mirror 81C to be focused on the surface of the photosensitive drum 5AC to form an image thereon.

The mirror 81K is a mirror configured to reflect the light beam BK that has passed through the scan lens 60CK toward the surface of the photosensitive drum 5AK.

The scan lens 70K is a lens configured to cause the light beam BK reflected off the mirror 81K to be focused on the surface of the photosensitive drum 5AK to form an image thereon.

As shown in FIG. 3, pencils of light emitted from each of the semiconductor lasers 10Y, 10M, 10C, and 10K pass through the corresponding coupling lenses 20Y, 20M, 20C, and 20K, and are thereby converted into light beams BY, BM, BC, and BK, respectively. Each of the light beams BY, BM, BC, and BK pass through the corresponding openings 31Y, 31M, 31C, and 31K of the first diaphragm wall 30A and then enters the condenser lens 40. The light beams BY, BM, BC, and BK that have passed through the condenser lens 40 pass through the corresponding openings 32A and 32B of the second diaphragm wall 30B and enter the polygon mirror 51.

As shown in FIG. 4, the polygon mirror 51 deflects the light beams BY, BM, BC, and BK toward the corresponding scanning optical systems Lo1 and Lo2. The light beam BY deflected toward the scanning optical system Lo1 passes through the scan lens 60YM, and is reflected off the mirror 81Y, by which the light beam BY is directed to pass through the scan lens 70Y and is emitted toward the photosensitive drum 5AY. The light beam BY is focused on the surface of the photosensitive drum 5AY to form an image thereon, which is thereby scanned with the light beam BY in the main scanning direction.

The light beam BM deflected toward the scanning optical system Lo1 passes through the scan lens 60YM, and is reflected off the mirrors 81M and 82M, by which the light beam BM is directed to pass through the scan lens 70M and is emitted toward the photosensitive drum 5AM. The light beam BM is focused on the surface of the photosensitive drum 5AM to form an image thereon, which is thereby scanned with the light beam BM in the main scanning direction.

The light beam BC deflected toward the scanning optical system Lo2 passes through the scan lens 60CK, and is reflected off the mirrors 81C and 82C, by which the light beam BC is directed to pass through the scan lens 70C and is emitted toward the photosensitive drum 5AC. The light beam BC is focused on the surface of the photosensitive drum 5AC to form an image thereon, which is thereby scanned with the light beam BC in the main scanning direction.

The light beam BK deflected toward the scanning optical system Lo2 passes through the scan lens 60CK, and is reflected off the mirror 81K, by which the light beam BK is directed to pass through the scan lens 70K and is emitted toward the photosensitive drum 5AK. The light beam BK is focused on the surface of the photosensitive drum 5AK to form an image thereon, which is thereby scanned with the light beam BK in the main scanning direction.

As shown in FIG. 5, the scanning optical device 4 further comprises light sensors 90 and mirrors 85. The polygon mirror 51 is caused to rotate in the counter-clockwise direction of FIG. 5.

The light sensors 90 are sensors configured to detect the light beams BY and BK deflected by the optical deflector 50 and then have passed through the scan lenses 60YM and 60CK. More specifically, the light sensors 90 include a light sensor 90Y and a light sensor 90K.

The light sensor 90Y is configured to detect the light beam BY that is deflected by the optical deflector 50 and then has passed through the scan lens 60YM. The light beam BY detected by the light sensor 90Y is a portion of the light beam BY which has passed through the scan lens 60YM and is directed to a position downstream, in the main scanning direction, of the scanning range which exposes the photosensitive drum 5AY (see FIG. 4).

The light sensor 90K is configured to detect the light beam BK that is deflected by the optical deflector 50 and then has passed through the scan lens 60CK. The light beam BK detected by the light sensor 90K is a portion of the light beam BK which has passed through the scan lens 60CK and is directed to a position upstream, in the main scanning direction, of the scanning range which exposes the photosensitive drum 5AK (see FIG. 4).

The mirrors 85 are mirrors configured to reflect the light beams BY and BK toward the corresponding light sensors 90. More specifically, the mirrors 85 include a mirror 85Y and a mirror 85K. The mirror 85Y is configured to reflect the light beam BY, deflected by the optical deflector 50 and then has passed through the scan lens 60YM, toward the light sensor 90Y. The mirror 85K is configured to reflect the light beam BK, deflected by the optical deflector 50 and then has passed through the scan lens 60CK, toward the light sensor 90K.

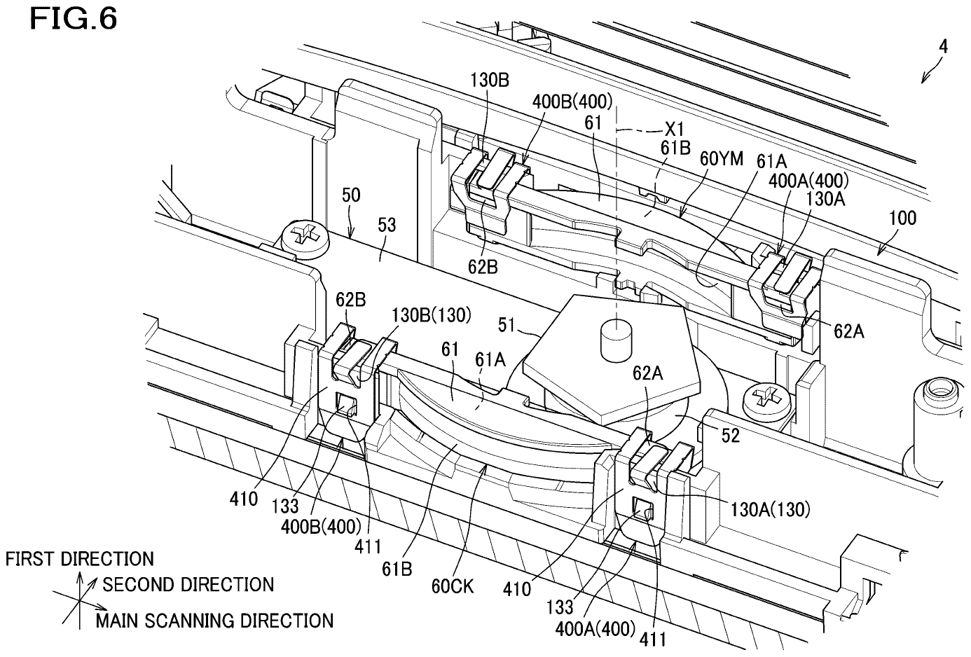

As shown in FIG. 6, the scanning optical device 4 further comprises a leaf spring 400. The leaf spring 400 is a member configured to fix the scan lenses 60YM and 60CK to the frame 100. The leaf spring 400 is made of a metal sheet. The frame 100 supports the optical deflector 50 and the scan lenses 60YM and 60CK.

In the present embodiment, the scan lens 60YM and its surroundings and the scan lens 60CK and its surroundings are arranged to be symmetrical with respect to a plane perpendicular to the second direction which passes through the rotation axis X1 of the polygon mirror 51. In the following, the structure of the scan lens 60CK and its surroundings will be mainly described.

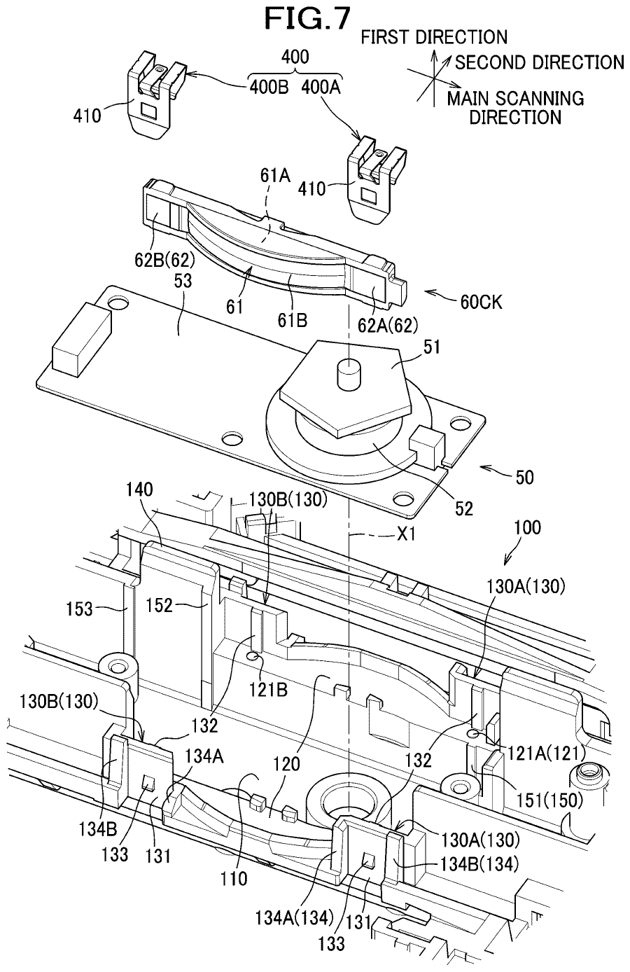

As shown in FIG. 7, the scan lens 60CK comprises a lens portion 61 and flanges 62.

The lens portion 61 is the portion comprising the optical surfaces through which the light beams pass. More specifically, the lens portion 61 comprises an incident-side surface 61A and an exit-side surface 61B. The incident-side surface 61A is a surface through which the light beams deflected by the optical deflector 50 enter the lens portion 61. The incident-side surface 61A is a concave surface and is an axisymmetric aspheric surface having axial symmetry with respect to the optical axes of the scan lenses 60YM and 60CK. The exit-side surface 61B is the surface of the lens portion 61 from which the light beams are emitted. The exit-side surface 61B is a convex surface and is an axisymmetric aspheric surface having axial symmetry with respect to the optical axes of the scan lenses 60YM and 60CK.

The flanges 62 are portions extending in the main scanning direction from ends of the lens portion 61 in the main scanning direction. More specifically, the flanges 62 include a first flange 62A and a second flange 62B. The first flange 62A extends from an end of the lens portion 61 on the one side in the main scanning direction toward the one side in the main scanning direction. The second flange 62B extends from an end of the lens portion 61 on the other side in the main scanning direction toward the other side in the main scanning direction. The frame 100 comprises a pedestal 120 and contact walls 130.

The pedestal 120 is a portion having a shape resembling a pedestal. The pedestal 120 supports the scan lenses 60YM and 60CK. The pedestal 120 protrudes from the frame base wall 110 toward the one side in the first direction. The pedestal 120 extends in the main scanning direction.

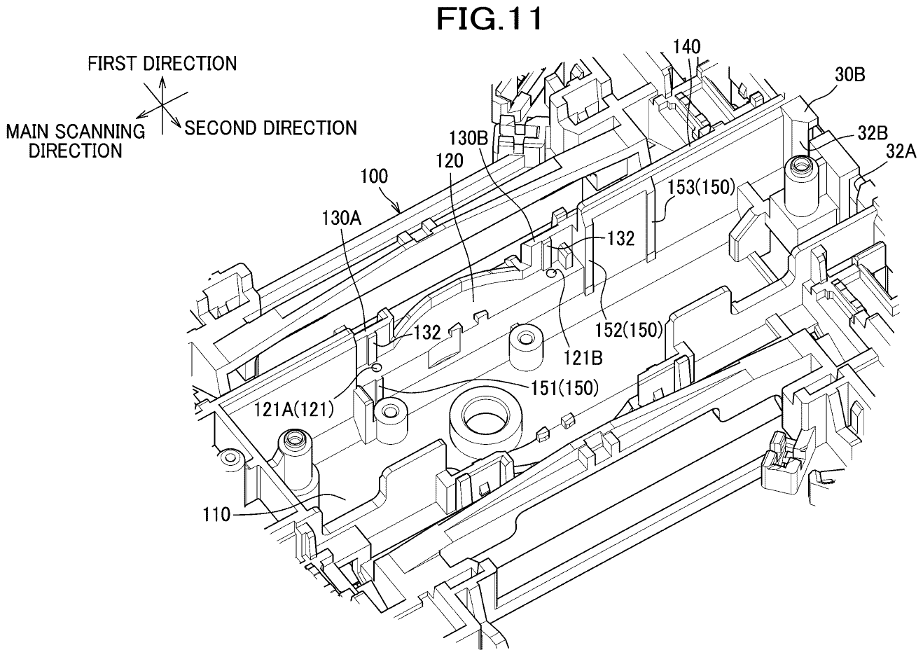

The pedestal 120 comprises protrusions 121 (see also FIG. 11). The protrusions 121 are portions which the flanges 62 of the scan lenses 60YM and 60CK contact in the first direction. More specifically, the protrusions 121 include a first protrusion 121A and a second protrusion 121B. The first flange 62A contacts the first protrusion 121A. The second flange 62B contacts the second protrusion 121B. The protrusions 121 (the protrusion 121A and the protrusion 121B) each protrudes from the pedestal 120 toward the one side in the first direction.

The contact walls 130 are walls which the flanges 62 of the scan lenses 60YM and 60CK contact in the second direction. More specifically, the contact walls 130 include a first contact wall 130A and a second contact wall 130B. The first flange 62A contacts the first contact wall 130A. The second flange 62B contacts the second contact wall 130B. The first contact wall 130A and the second contact wall 130B are spaced apart from each other in the main scanning direction.

The contact walls 130 (first contact wall 130A and the second contact wall 130B) each comprises a wall body 131, a contact rib 132, a protrusion 133, and spring guide ribs 134.

The wall body 131 protrudes from the pedestal 120 toward the one side in the first direction. The wall body 131 extends in the main scanning direction.

The contact rib 132 is a portion which the flange 62 contacts. The contact rib 132 protrudes inward from the wall body 131 in the second direction. Inward in the second direction is toward a side closer to the rotation axis X1 in the second direction.

In more detail, the contact ribs 132 of the contact walls 130 located closer to the one side in the second direction protrudes toward the other side in the second direction. The contact ribs 132 of the contact walls 130 located closer to the other side in the second direction protrudes toward the one side in the second direction. As an example, the flanges 62 of the scan lens 60CK contact the contact ribs 132 of the contact walls 130 located closer to the other side in the second direction from the one side in the second direction.

The contact rib 132 extends in the first direction. The position of the contact rib 132 of the first contact wall 130A in the main scanning direction overlaps a position of the first protrusion 121A of the pedestal 120 in the man scanning direction. The position of the contact rib 132 of the second contact wall 130B in the main scanning direction overlaps a position of the second protrusion 121B of the pedestal 120 in the main scanning direction.

The protrusion 133 protrudes outward from the wall body 131 in the second direction. Outward in the second direction is toward a side farther from the rotation axis X1 in the second direction. A surface of the protrusion 133 facing the one side in the first direction is an inclined surface which is inclined in such a manner that the further the surface is located toward the other side in the first direction, the further the surface is located outward in the second direction. The surface of the protrusion 133 facing the other side in the first direction is a flat surface perpendicular to the first direction.

The spring guide ribs 134 are ribs that contact the leaf spring 400 and guides the leaf spring 400 when the leaf spring 400 is attached to the frame 100. The spring guide ribs 134 protrude outward from the wall body 131 in the second direction. The spring guide ribs 134 extend in the first direction.

The spring guide ribs 134 include a first spring guide rib 134A and a second spring guide rib 134B. The first spring guide rib 134A and the second spring guide rib 134B are spaced apart from each other in the main scanning direction. The first spring guide rib 134A is located inward in the main scanning direction. Inward in the main scanning direction is toward a side closer to the rotation axis X1 in the main scanning direction. The second spring guide rib 134B is located outward in the main scanning direction. Outward in the main scanning direction is toward a side farther from the rotation axis X1 in the main scanning direction. The protrusion 133 is located between the first spring guide rib 134A and the second spring guide rib 134B in the main scanning direction.

In the present embodiment, the dimension of the first spring guide rib 134A of the second contact wall 130B in the first direction is smaller than the dimension of the second spring guide rib 134B of the second contact wall 130B in the first direction. Furthermore, the wall body 131 of the second contact wall 130B has a shape in which a portion of the first guide rib 134A on the one side in the first direction is cut away, compared to the wall body 131 of the first contact wall 130A. As a result, the light beams BY and BK deflected by the optical deflector and heading toward the light sensors 90 (see FIG. 5) do not interfere with the second contact walls 130B.

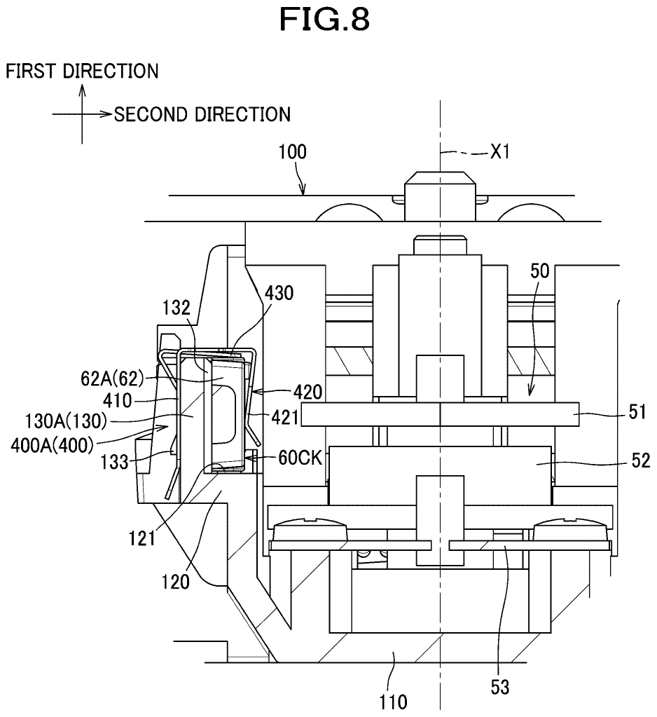

As shown in FIG. 8, the contact walls 130 (contact wall 130A and contact wall 130B) are farther, than the flange 62, from the rotation axis X1 of the polygon mirror 51 in the second direction. In other words, the flange 62 is located between the contact walls 130 (contact wall 130A and contact wall 130B) and the rotation axis X1 in the second direction. Furthermore, the flange 62 is located between the contact walls 130 (contact wall 130A and contact wall 130B) and the polygon mirror 51 in the second direction.

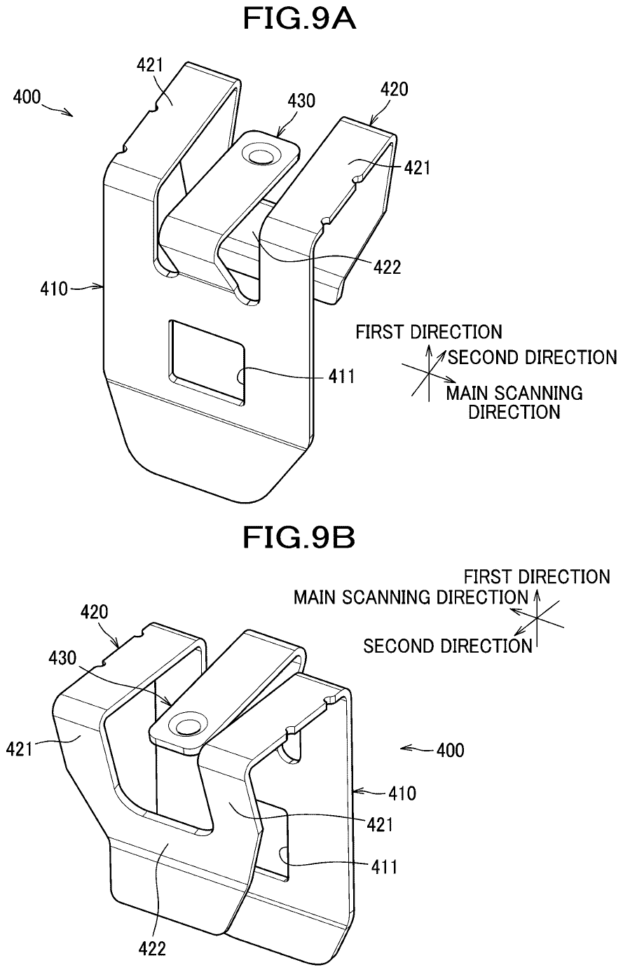

As shown in FIG. 8, FIG. 9A, and FIG. 9B, the leaf spring 400 includes a base 410, a first arm 420, and a second arm 430.

The base 410 is a portion which contacts the contact wall 130 from a side opposite to the flange 62 in the second direction. A through hole 411 is formed in the base 410. The through hole 411 extends in the second direction. The through hole 411 is engaged with the protrusion 133 of the contact wall 130 in a state where the leaf spring 400 is attached to the frame 100 to fix one of the scan lenses 60YM and 60CK on the frame 100 (see FIG. 6). The spring 400 can be restrained from being detached from the frame 100 by the through hole 411 of the base 410 being engaged with the protrusion 133.

The first arm 420 is a portion which holds the contact wall 130 and the flange 62 in combination with the base 410. The first arm 420 biases the flange 62 toward the contact wall 130. The first arm 420 extends from an end portion of the base 410 on the one side in the first direction. More specifically, the first arm 420 includes two arm portions 421 and a connecting portion 422.

The two arm portions 421 are spaced apart from each other in the main scanning direction. The arm portions 421 hold the contact wall 130 and the flange 62 in combination with the base 410. Each of the arm portions 421 extends from the end portion of the base 410 on the one side in the first direction. More specifically, the arm portions 421 extend from the end portion of the base 410 on the one side in the first direction toward the one side in the first direction, then are bent inward in the second direction and extend inward in the second direction across the contact wall 130 and the flange 62, and then are bent toward the other side in the first direction and extend toward the other side in the first direction.

The connecting portion 422 extends in the main scanning direction and connects the two arm portions 421. More specifically, the connecting portion 422 connects an end portion of one of the arm portions 421 opposite to the base 410 with an end portion of the other of the arm portions opposite to the base 410.

The second arm 430 is located between the two arm portions 421 in the main scanning direction. The second arm 430 extends from the end portion of the base 410 on one side in the first direction. More specifically, the second arm 430 extends from the end of the base 410 on the one side in the first direction toward one side in the first direction, and then is bent inward in the second direction and extends inward in the second direction. The second arm 430 contacts an end portion of the flange 62 on the one side in the first direction and biases the flange 62 toward the other side in the first direction.

As shown in FIG. 6, the leaf spring 400 comprises a first leaf spring 400A and a second leaf spring 400B. The first leaf spring 400A holds the first contact wall 130A and the first flange 62A. The second leaf spring 400B holds the second contact wall 130B and the second flange 62B. The first leaf spring 400A and the second leaf spring 400B are members having the same shape.

In the present embodiment, the scanning optical device 4 comprises two first leaf springs 400A and two second leaf springs 400B. Furthermore, the scanning optical device 4 comprises a first leaf spring 400A and a second leaf spring 400B for fixing the scan lens 60YM on the frame 100, and a first leaf spring 400A and a second leaf spring 400B for fixing the scan lens 60CK on the frame 100.

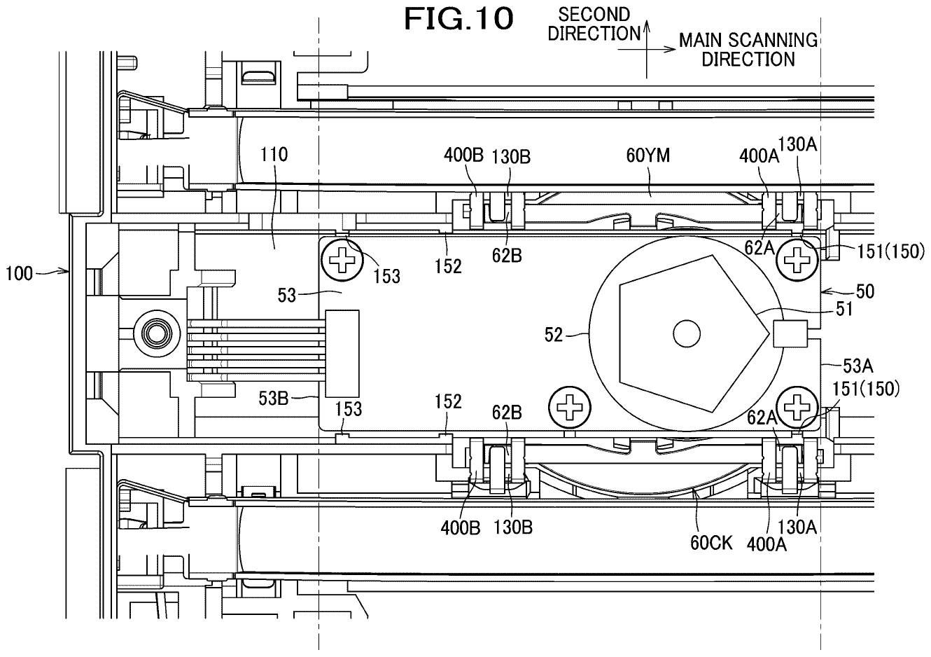

As shown in FIG. 10, each of the first leaf springs 400A and the second leaf springs 400B does not overlap the optical deflector 50 as viewed in the first direction. More specifically, each of the first leaf springs 400A and the second leaf springs 400B does not overlap the support board 53 of the optical deflector 50 as viewed in the first direction. In other words, each of the first leaf springs 400A and the second leaf springs 400B are located outward in the second direction with respect to the support plate 53.

Each of the first springs 400A and the second springs 400B are located between one end 53A of the support plate 53on the one side in the main scanning direction and the other end 53B of the support plate 53on the other side in the main scanning direction. In other words, each of the first leaf springs 400A and the second leaf springs 400B are located within a range of the support plate 53 in the main scanning direction (between the two dashed-dotted lines shown in FIG. 10).

As shown in FIG. 11, the frame 100 further comprises a partition wall 140 and a plurality of plate guide ribs 150. In the present embodiment, the plate guide ribs 150 correspond to the “ribs”.

The partition wall 140 is a wall protruding from the frame base wall 110 toward the one side in the first direction. The partition wall 140 extends in the main scanning direction. One end portion of the partition wall 140 on the one side in the main scanning direction is connected to the pedestal 120. The other end portion of the partition wall 140 on the other side in the main scanning direction is connected to the second diaphragm wall 30B. The partition wall 140 extends further toward the one side in the first direction than the pedestal 120.

The plate guide ribs 150 are ribs extending in the first direction. The plurality of plate guide ribs 150 are arranged next to each other in the main scanning direction. More specifically, the plate guide ribs 150 include a first plate guide rib 151, a second plate guide rib 152, and a third plate guide rib 153.

The second plate guide rib 152 and the third plate guide rib 153 protrudes inwards from the partition wall 140 in the second direction. The second plate guide rib 152 is located at one end portion of the partition wall 140 on the one side in the main scanning direction. The third plate guide rib 153 is located on the other side in the main scanning direction with respect to the second plate guide rib 152 at a position spaced apart from the second plate guide rib 152 in the main scanning direction.

The first plate guide rib 151 protrudes inward from the pedestal 120 in the second direction. The dimension of the first plage guide rib 151 in the first direction is smaller than the dimension of the second plate guide rib 152 in the first direction. The dimension of the first plate guide rib 151 in the first direction is smaller than the dimension of the third plate guide rib 153 in the first direction. The dimension of the first plate guide rib 151 in the first direction is almost the same as the dimension of the pedestal 120 in the first direction.

The first plate guide rib 151 is located on the one side in the main scanning direction with respect to the second plate guide rib 152 at a position spaced apart from the second plate guide rib 152 in the main scanning direction. The position of the first plate guide rib 151 in the main scanning direction overlaps the first contact wall 130A. The first plate guide rib 151 is located at a position in which a part of the first plate guide rib 151 overlaps the contact rib 132 of the first contact wall 130A and the first protrusion 121A of the pedestal 120 in the main scanning direction.

As shown in FIG. 10, the frame 100 comprises the plurality of plate guide ribs 150 (151 to 153) at both sides of the support plate 53 in the second direction (see also FIG. 7). The plate guide ribs 150 (151 to 153) are ribs which contact the support plate 53 of the optical deflector 50 in the second direction and guides the support plate 53 when the optical deflector 50 is attached to the frame 100.

Next, the advantageous effects of the present embodiment will be described.

The contact wall 130 of the frame 100 is farther, than the flanges 62 of the scan lenses 60YM and 60CK, from the rotation axis X1 of the polygon mirror 51 in the second direction; thus, clearance between the polygon mirror 51 and the contact wall 130 can be secured even if the distances between the polygon mirror 51 and the scan lenses 60 YM and 60CK become smaller. As a result, for example, the leaf spring 400 can be restrained from interfering with the polygon mirror 51 when the leaf spring 400 is attached to the frame 100.

The first arm 420 includes the two arm portions 421; thus, the load for biasing the flange 62 toward the first contact wall 130 can be obtained.

The first arm 420 includes the connecting portion 422 connecting the two arm portions 421; thus, the first arm 420 comprising the two arm portions 421 can be moved as one when the leaf spring 400 is attached to the frame 100. As a result, the leaf spring 400 can be attached to the frame 100 easily.

The leaf spring 400 includes a first arm 420 and a second arm 430; thus, the flange 62 can be biased in the second direction toward the contact wall 130 and biased in the first direction by a single leaf spring 400.

The leaf spring 400 does not overlap the support plate 53 of the optical deflector 50 as viewed in the first direction; thus, the leaf spring 400 and the optical deflector 50 can be restrained from interfering with each other when the leaf spring 400 or the optical deflector 50 is attached to the frame 100 along the first direction.

The first leaf spring 400A and the second leaf spring 400B are located between the one end 53A of the support plate 53 on the one side in the main scanning direction and the other end 53B of the support plate 53 on the other side in the main scanning direction; thus, the scan lenses 60YM and 60CK, the first leaf spring 400A, the second leaf spring 400B, and the optical deflector 50 can be disposed in a compact manner in the main scanning direction.

The frame 100 comprises the plurality of the plate guide ribs 150 (151 to 153) which guide the support plate 53 when the optical deflector 50 is attached to the frame 100; thus, the optical deflector 50 can be restrained from interfering with the leaf spring 400 when the optical deflector 50 is attached to frame 100.

The frame 100 comprises the plurality of the plate guide ribs 150 (151 to 153) on both sides of the support plate 53 in the second direction; thus, the optical deflector 50 can be further restrained from interfering with the leaf spring 400 when the optical deflector 50 is attached to frame 100.

The incident-side surfaces 61A of the scan lenses 60YM and 60CK are concave surfaces; thus, clearance between the polygon mirror 51 and the incident-side surfaces 61A of the scan lenses 60YM and 60CK can be secured even when the distance between the polygon mirror 51 and the scan lenses 60YM and 60CK become smaller. As a result, for example, noise caused by airflow generated by the rotation of the polygon mirror 51 can be restrained.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the present embodiment, as shown in FIG. 10, both the first leaf spring 400A and the second leaf spring 400B are located between the one end 53A of the support plate 53 on the one side in the main scanning direction and the other end 53B of the support plate 53 on the other side in the main scanning direction. However, for example, only one of the first leaf spring or the second leaf spring may be located between the one end of the support plate on the one side in the main scanning direction and the other end of the support plate on the other side in the main scanning direction. In other words, the other one of the first leaf spring or the second leaf spring may be located at a position in which a portion of the leaf spring or the entire leaf spring is located outward of the support plate in the main scanning direction. Further, both the first leaf spring and the second leaf spring may be located at positions in which portions of the leaf springs or the entire leaf springs are located outward of the support plate in the main scanning direction.

In the present embodiment, the frame 100 comprises the plate guide ribs 150 (151 to 153) as the plurality of ribs on both sides of the support plate 53 of the optical deflector 50 in the second direction. However, for example, the frame may comprise the plurality of ribs on only one side of the support plate in the second direction. Further, for example, the frame may not comprise the ribs for guiding the support plate when the optical deflector is attached to the frame.

In the present embodiment, the scanning optical device 4 comprises the flange 62, the contact wall 130, and the leaf spring 400 on both sides of the scan lenses 60YM and 60CK in the main scanning direction. However, for example, the scanning optical device may comprise the flange, the contact wall, and the leaf spring on only one side of the scan lenses in the main scanning direction.

In the present embodiment, the leaf spring 400 does not overlap the support plate 53 of the optical deflector 50 as viewed in the first direction. However, for example, the leaf spring may overlap the support plate as viewed in the first direction. In the present embodiment, the leaf spring 400 comprises the second arm 430. However, for example, the leaf spring may not comprise the second arm.

In the present embodiment, the first arm 420 of the leaf spring 400 includes the connecting portion 422 connecting the two arm portions 421. However, for example, the first arm may not include a connecting portion. In the present embodiment, the first arm 420 includes two arm portions 421. However, for example, the first arm may have only one arm portion.

In the present embodiment, the scanning optical device 4 comprises a plurality of the light source units LM1 and LM2 and the scan lenses 60YM and 60CK. However, for example, there may be only one light source unit or scan lens. In the present embodiment, the scanning optical device 4 is a scanning optical device used in the image forming apparatus 1 such as a laser printer. However, for example, the scanning optical device may be a scanning optical device used in an apparatus other than an image forming apparatus.

The elements described in the above embodiment and its modifications may be implemented selectively and in combination.

What is claimed is:

1. A scanning optical device, comprising:
a light source configured to emit a light beam;
an optical deflector configured to deflect the light beam in a main scanning direction, the optical deflector comprising a polygon mirror rotatable about a rotation axis extending in a first direction perpendicular to the main scanning direction;
a scanning optical system configured to cause the light beam deflected by the optical deflector to be focused on a scanning surface to form an image thereon, the scanning optical system comprising a scan lens through which the light beam deflected by the optical deflector passes;
a frame configured to support the optical deflector and the scan lens; and
a leaf spring configured to fix the scan lens to the frame,
wherein the scan lens comprises:
a lens portion; and
a flange extending from an end of the lens portion in the main scanning direction;
wherein the frame comprises a contact wall in contact with the flange in a second direction perpendicular to the main scanning direction and to the first direction, the contact wall positioned further away, than the flange, from the rotation axis in the second direction, and
wherein the leaf spring includes:
a base in contact with a side of the contact wall opposite to the flange in the second direction; and
a first arm extending from an end of the base on one side in the first direction, the first arm configured to hold the contact wall and the flange in combination with the base.

2. The scanning optical device according to claim 1, wherein the first arm includes two arm portions extending from the end of the base on the one side in the first direction and spaced apart from each other in the main scanning direction, the two arm portions configured to hold the contact wall and the flange in combination with the base.

3. The scanning optical device according to claim 2, wherein the first arm further comprises a connecting portion extending in the main scanning direction, the connecting portion connecting an end portion of one of the arm portions opposite to the base with an end portion of another of the arm portions opposite to the base.

4. The scanning optical device according to claim 2, wherein the leaf spring further includes a second arm extending from the end of the base on the one side in the first direction and positioned between the two arm portions in the main scanning direction, the second arm configured to contact an end of the flange on the one side in the first direction.

5. The scanning optical device according to claim 1, wherein the optical deflector further comprises a support plate configured to support the polygon mirror, and
wherein the leaf spring does not overlap the support plate as viewed in the first direction.

6. The scanning optical device according to claim 5, wherein
the flange is a first flange extending from one end of the lens portion on one side in the main scanning direction;
the contact wall is a first contact wall configured to contact the first flange; and
the leaf spring is a first leaf spring configured to hold the first contact wall and the first flange,
wherein the scanning optical device further comprises:
a second flange extending from another end of the lens portion on another side in the main scanning direction;
a second contact wall configured to contact the second flange; and
a second leaf spring configured to hold the second contact wall and the second flange,
wherein at least one of the first leaf spring or the second leaf spring is positioned between one end of the support plate on the one side in the main scanning direction and another end of the support plate on the another side in the main scanning direction.

7. The scanning optical device according to claim 6, wherein
both the first leaf spring and the second leaf spring is positioned between the one end of the support plate on the one side in the main scanning direction and the another end of the support plate on the another side in the main scanning direction.

8. The scanning optical device according to claim 5, wherein the frame comprises:
a wall extending in the main scanning direction and the first direction; and
a plurality of ribs protruding from the wall toward the rotation axis in the second direction, the plurality of ribs extending in the first direction and arranged in the main scanning direction.

9. The scanning optical device according to claim 8, wherein the plurality of ribs are disposed on each side of the support plate in the second direction.

10. The scanning optical device according to claim 1, wherein the scan lens comprises an incident-side surface through which the light beam deflected by the optical deflector enters the scan lens, and
wherein the incident-side surface is a concave surface.

11. An image forming apparatus, comprising:
a photosensitive drum; and
a scanning optical device comprising:
a light source configured to emit a light beam;
an optical deflector configured to deflect the light beam in a main scanning direction, the optical deflector comprising a polygon mirror rotatable about a rotation axis extending in a first direction perpendicular to the main scanning direction;
a scanning optical system configured to cause the light beam deflected by the optical deflector to be focused on a surface of the photosensitive drum to form an image thereon, the scanning optical system comprising a scan lens through which the light beam deflected by the optical deflector passes;
a frame configured to support the optical deflector and the scan lens; and
a leaf spring configured to fix the scan lens to the frame,
wherein the scan lens comprises:
a lens portion; and
a flange extending from an end of the lens portion in the main scanning direction;
wherein the frame comprises a contact wall in contact with the flange in a second direction perpendicular to the main scanning direction and to the first direction, the contact wall positioned further away, than the flange, from the rotation axis in the second direction, and
wherein the leaf spring includes:
a base in contact with a side of the contact wall opposite to the flange in the second direction; and
a first arm extending from an end of the base on one side in the first direction, the first arm configured to hold the contact wall and the flange in combination with the base.

12. The image forming apparatus according to claim 11, wherein the first arm includes two arm portions extending from the end of the base on the one side in the first direction and spaced apart from each other in the main scanning direction, the two arm portions configured to hold the contact wall and the flange in combination with the base.

13. The image forming apparatus according to claim 12, wherein the first arm further comprises a connecting portion extending in the main scanning direction, the connecting portion connecting an end portion of one of the arm portions opposite to the base with an end portion of another of the arm portions opposite to the base.

14. The image forming apparatus according to claim 12, wherein the leaf spring further includes a second arm extending from the end of the base on the one side in the first direction and positioned between the two arm portions in the main scanning direction, the second arm configured to contact an end of the flange on the one side in the first direction.

15. The image forming apparatus according to claim 11, wherein the optical deflector further comprises a support plate configured to support the polygon mirror, and
wherein the leaf spring does not overlap the support plate as viewed in the first direction.

16. The image forming apparatus according to claim 15, wherein
the flange is a first flange extending from one end of the lens portion on one side in the main scanning direction;
the contact wall is a first contact wall configured to contact the first flange; and
the leaf spring is a first leaf spring configured to hold the first contact wall and the first flange,
wherein the scanning optical device further comprises:
a second flange extending from another end of the lens portion on another side in the main scanning direction;
a second contact wall configured to contact the second flange; and
a second leaf spring configured to hold the second contact wall and the second flange,
wherein at least one of the first leaf spring or the second leaf spring is positioned between one end of the support plate on the one side in the main scanning direction and another end of the support plate on the another side in the main scanning direction.

17. The image forming apparatus according to claim 16, wherein
both the first leaf spring and the second leaf spring is positioned between the one end of the support plate on the one side in the main scanning direction and the another end of the support plate on the another side in the main scanning direction.

18. The image forming apparatus according to claim 15, wherein the frame comprises:
a wall extending in the main scanning direction and the first direction; and
a plurality of ribs protruding from the wall toward the rotation axis in the second direction, the plurality of ribs extending in the first direction and arranged in the main scanning direction.

19. The image forming apparatus according to claim 18, wherein the plurality of ribs are disposed on each side of the support plate in the second direction.

20. The image forming apparatus according to claim 11, wherein the scan lens comprises an incident-side surface through which the light beam deflected by the optical deflector enters the scan lens, and
wherein the incident-side surface is a concave surface.
